(19) United States
(12) Patent Application Publication
(10) Pub. No.: US 2015/0136196 A1
(43) Pub. Date: May 21, 2015

(54) SELF-CLEANING SOLAR PANEL DESIGN

(71) Applicant: Mark Edward Williamson, Merkel, TX (US)

(72) Inventor: Mark Edward Williamson, Merkel, TX (US)

(21) Appl. No.: 14/086,857

(22) Filed: Nov. 21, 2013

(51) Int. Cl. H01L 31/042

(52) U.S. Cl. CPC H02S 40/00
USPC 136/244

(57) ABSTRACT

A self-cleaning photovoltaic module which when combined with other identical modules forms a large solar panel which is protected from the vice of dust deposition. The module, which has all the properties of a solar panel in itself, has a dividing fin and a circular vent capable of flushing out the water along with the dust deposited on the module. The fins, which form a dam like structure, along with the aid of gravity guide the condensed atmospheric moisture along with the dust to the circular vents present on the corners of the photovoltaic module. The invention overcomes the difficulty of effectively self-cleaning a solar panel without much costs being involved.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

This Invention generally relates to photovoltaic cell assemblies for converting solar energy into electrical energy. Particularly it relates to more efficient use of photovoltaic cell assemblies by maintaining a cleaner surface by removal and prevention of dust deposition.

From the past few decades the demand for solar energy has increased manifold. Absorption of light by the photovoltaic cells causes the production of electrical energy. This whole process of production of electrical energy is primarily based upon the absorption of solar energy by the photovoltaic cells. Transparency to light plays the most important role in making these solar panels efficient for effective use. One of the most vital problems faced in this process of generation of electrical energy is the deposition of dust particle on the surface of the panel. These dust particles if not cleaned at regular interval form a thick layer of mud and hence they reduce the transparency to light.

Typically the usage of solar panels is prone to dust deposition and mud formation in all kind of terrains. Various solutions to this problem of dust and mud deposition on solar panels have been designed but none of them is cost effective and entirely successful. To the knowledge of the inventor, none of the current solutions utilize the single day cycle of dew deposited on the panel from the atmosphere to clean a solar panel automatically. References mentioned in this section are not admitted to be prior art for the purposes of the instant invention.

U.S. Pat. No. 4,321,419 to Hanafin discloses a transparent protective cover for a solar panel. The cover includes a pair of rollers on opposite sides of the solar panel supporting a supply of film material. Clean film material is advanced over the solar panel to prevent excessive dust accumulation. Likewise, in U.S. Pat. No. 6,911,593 B2 to Mazumder a transparent self-cleaning dust shield has been disclosed. It uses the process of electromagnetism to clean the solar panel and like surfaces.

The limitations and the non-cost effectiveness of prior art are overcome by the instant invention as described below.

### BRIEF SUMMARY OF THE INVENTION

The solar panel formed through this invention is effectively a collection of rectangular or square photovoltaic modules which are of small length and breadth of around 8 (eight) inches. These square or rectangular photovoltaic modules are designed in such a manner that they independently utilize the dew deposited on them for self-cleaning purpose.

The square or rectangular photovoltaic module has fins throughout the perimeter and in addition it has circle sectors or circle segments on all the four corners. When these photovoltaic modules are combined together, circular vents are formed in middle of four combined modules and the modules are separated from each other by the fins.

The dust deposited on the solar panel is collected by the dew and while the dew moves downwards it leaves behind a cleaner surface and it is ultimately guided towards the corner of the square or rectangular module, which is a circular vent. This leaves behind a self cleaned solar panel. This invention provides for a throughout self-cleaning of the panel and solves the previously existing problem of extremely dirty bottom half of solar panels.

It is the object of this invention to provide for a natural and cost effective solution to the problem of dust and mud deposition on solar panels.

These and other features, objects and advantages of the present invention will be readily apparent to persons of ordinary skill in the art upon reading the entirety of this disclosure, which includes the accompanying drawings and claims.

### BRIEF DESCRIPTION OF THE SEVERAL VIEWS OF THE DRAWING

FIG. 1 shows an isometric view of the self-cleaning photovoltaic module.

FIG. 2 shows a front view of the self-cleaning photovoltaic module.

FIG. 3 shows a top view of the self-cleaning l photovoltaic module.

FIG. 4 shows a cross sectional view of the self-cleaning photovoltaic module.

FIG. 5 shows an isometric view of a solar panel assembly which is made by a combination of self-cleaning photovoltaic modules.

FIG. 6 shows a side view of a solar panel assembly which is made by a combination of self-cleaning photovoltaic modules.

### DETAILED DESCRIPTION OF THE INVENTION

In the present disclosure, numerous specific details are provided, such as examples of module, components, and method, to provide a thorough understanding of embodiments of the invention. Persons of ordinary skill in the art will recognize, however, that the invention can be practiced without one or more of the specific details. In other instances, well-known details are not shown.

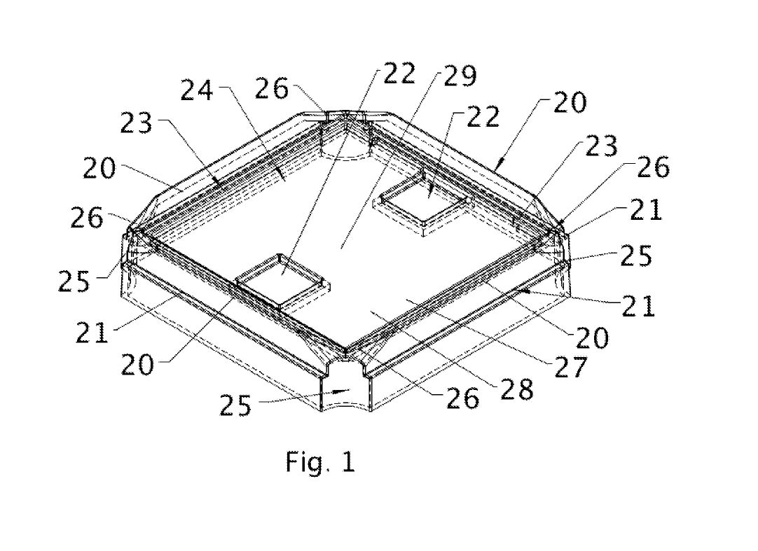

FIG. 1 shows a top left view of a self-cleaning photovoltaic module in accordance with the complex design requirements of the present invention. A self-cleaning photovoltaic module consists of dividing fins 20 which rise upward from the transparent protective element 29 and are swept at an outward angle of approximately thirty degrees. The fins 20 form a dam like structure, throughout the perimeter of the photovoltaic module and essentially help in preventing the flow of water collected from one self-cleaning module to another self-cleaning module. The water collected on self-cleaning photovoltaic module is used for cleaning that module only because only a very small quantity of water is collected from the atmosphere and to maintain a sufficient flow of the same, it becomes necessary to limit the surface area on which it has to flow along with the dust particles. The special design of the fins 20 create a corral effect and are able to channel more water towards the circular vent 25. The fins 20 taper downward at each corner and develop into fluted angles toward the circular vent 25 and act as a cutout to guide the water towards the circular vent 25. The body of this self-cleaning photovoltaic module shown in FIG. 1 shall be injection molded out of special UV resistant polymer materials but could be made from a variety of moldable materials. The shape of the circular vent 25 shall not necessarily be circular, as a variation in design is also possible but such variation may decrease the overall efficiency of the invention.

The water which gets deposited on the self-cleaning photovoltaic module is essentially the moisture of the atmosphere in the condensed form. The self-cleaning photovoltaic module cools by radiating its heat and in turn condenses the atmospheric moisture at a rate greater than that at which it can evaporate which results in the formation of water droplets. This naturally occurring cycle which is able to provide a small quantity of water to the self-cleaning photovoltaic module, has never been utilized in providing complete self-cleaning of a solar panel or any other like product. Also this invention becomes cost effective by effectively taking benefit of a process which happens every day without any intentional human intervention.

Every self-cleaning photovoltaic module is provided with a stackable step 21 which is located on the outer wall and slightly wider than the thickness of the shell material to accommodate stacking of the self-cleaning photovoltaic module for simplified storage and transportation.

The self-cleaning photovoltaic modules are provided with a electric junction recess 22 which is a small recess area residing beneath the cell module to accommodate the joining of the module with the exit wires. The modules also have a transparent protective element assembly step 23, which is the seat location where transparent protective material is joined to the self-cleaning photovoltaic module.

The photovoltaic cell module 27 which is a wafer-based crystalline silicon cell or thin-film cell based on cadmium telluride or silicon is accommodated on the photovoltaic module bed 24.

A cell cooling chamber 28 is also provided in the self-cleaning photovoltaic module. The self-cleaning photovoltaic module may also use a transparent protective element 29 which seals and protects the photovoltaic cell module 27 within the module bed 24.

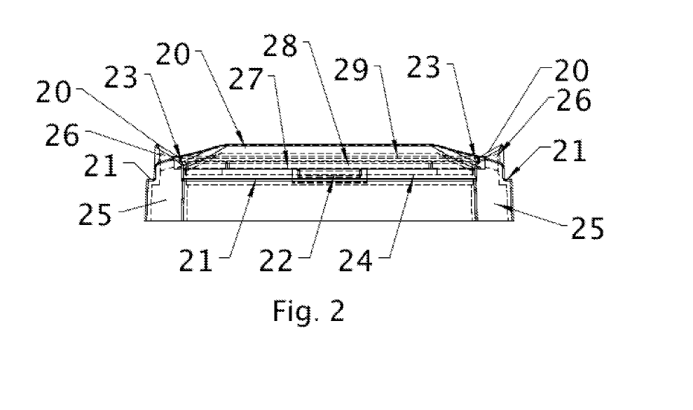

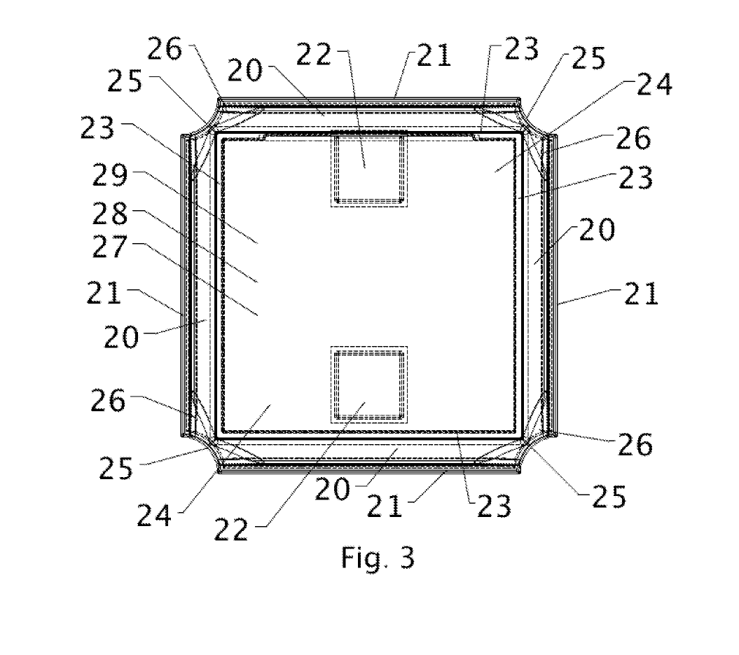

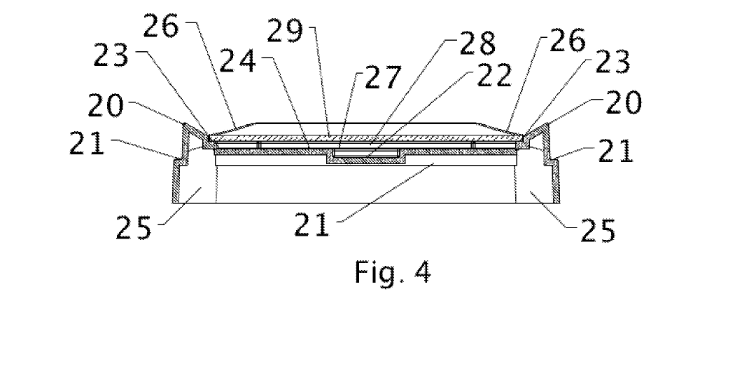

FIG. 2, FIG. 3 and FIG. 4 show the self-cleaning photovoltaic module in different views for more clarity as to the details of the part specified above.

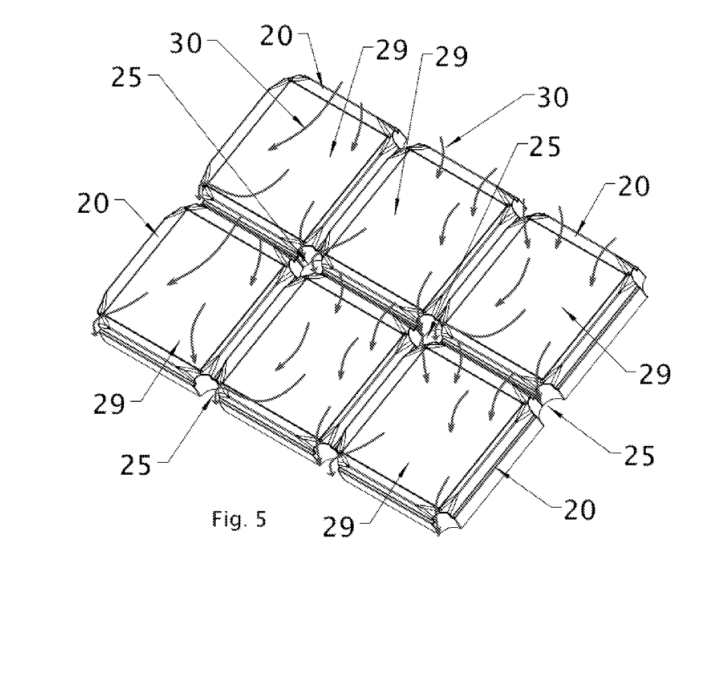

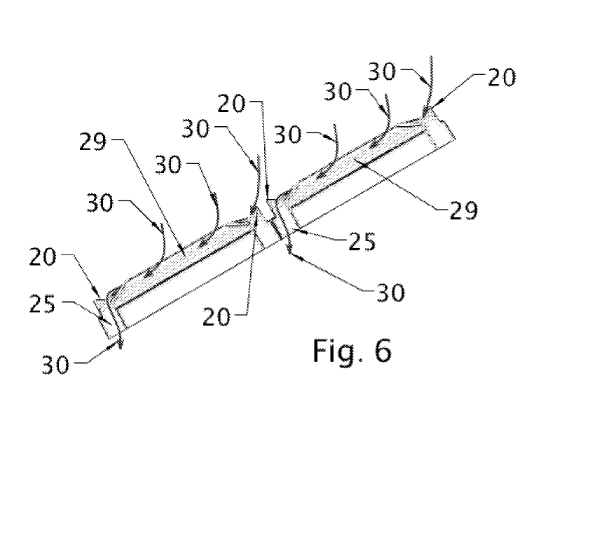

FIG. 5 and FIG. 6 shows a combination of self-cleaning photovoltaic modules which is essentially a solar panel assembly. Water 30 moves downwards carrying through it all the dust deposited on the self-cleaning photovoltaic module because of gravity and with the help of the fins 20 it finally leaves the self-cleaning photovoltaic module through the circular vent 25. This process of water 30 leaving the self-cleaning photovoltaic module through the circular vent 25 continues simultaneously on all the self-cleaning photovoltaic modules and provides a complete self-cleaned solar panel assembly.

While specific embodiments of the present invention have been provided, it is to be understood that these embodiments are for illustration purposes and not limiting. Many additional embodiments will be apparent to persons of ordinary skill in the art reading this disclosure. The main embodiments which form the essential part of the invention per se are the fins 20, circular vent 25 and water flush cutouts 26.

What is claimed is:

1. A self-cleaning photovoltaic module which when combined together with other identical photovoltaic modules forms a big, self-cleaning solar panel assembly.

2. The self-cleaning photovoltaic module in claim 1 having capability of acting as a solar panel on its own as well.

3. The self-cleaning photovoltaic module of claim 2 comprising of:
dividing fins that rise upward from the transparent protective element, are swept at an outward angle of approximately thirty degrees and run throughout the perimeter of the module;
water flush cutouts which are formed as the dividing fins taper downward at each end and develop into fluted angles toward the water outlet holes and act as a cutout to guide the water toward the self-cleaning circular vents;
circular vents which are the holes from which the water along with the collected dust leaves the self-cleaning photovoltaic module;
wherein the dividing fins, water flush cutout and the circular vent provide for self-cleaning of the module.

4. The self-cleaning photovoltaic module of claim 3 further comprising of:
the capability of using the condensed moisture of the atmosphere for self-cleaning the module by removing dust and other debris collected on the module;
means to effectively guide the water along with the collected dust to circular vents and in the process providing a self-cleaned module;
the capability of getting combined with other modules to form a complete solar panel.

5. The self-cleaning photovoltaic module of claim 4 preferably made out of special UV resistant polymer materials.
